(19) United States
(12) Patent Application Publication
(10) Pub. No.: US 2004/0150632 A1
(43) Pub. Date: Aug. 5, 2004

(54) Ballpoint stylus

(76) Inventor: Edward O. Clapper, Tempe, AZ (US)

Correspondence Address: INTEL CORPORATION, P.O. BOX 5326, SANTA CLARA, CA, 95056-5326, US

(21) Appl. No.: 10/355,476

(22) Filed: Jan. 31, 2003

(51) Int. Cl. G09G 5/00

(52) U.S. Cl. 345/179

(57) ABSTRACT

A ballpoint stylus is used as an input device with a touch-sensitive surface. The ballpoint stylus includes a tip and a ball coupled to the tip. The ball is partially protruding from an open cavity at the tip within a collar. When only the ball is in contact with the touch-sensitive surface, a first mouse action is recognized. When the collar is in contact with the touch-sensitive surface, a second mouse action is recognized. The ballpoint stylus may include two tips enabling it to be used to initiate multiple mouse actions.

### FIELD OF THE INVENTION

The present invention relates generally to the field of computer systems, and more specifically relating to methods and apparatuses for interacting with the computer systems.

### BACKGROUND

Computer systems are becoming increasingly pervasive in our society, including everything from small handheld electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, workstations, and servers.

Typically, a user interacts with a computer system using a combination of a keyboard and a mouse. In a two-button mouse, user interface functions include mouse movement, left button down, left button up, right button down and right button up. With each mouse movement, current X-Y coordinates of a corresponding mouse cursor are reported.

A mouse click is defined as a sequence of button down event followed by button up event. Moving the mouse (or an associated cursor) without either button being activated is sometimes referred to as hover. Hover is an important user interface capability for many applications where passing the mouse cursor over an object (e.g., an icon) may cause additional information (hovering information) to be displayed, for example, in a pop up window.

When using computer systems such as web tablets, personal digital assistants (PDA's), etc., users rely on a touch screen and a stylus instead of a mouse to interact with the devices. This is because the mobile usage requirements and device form factors (e.g., small display screen, etc.) of these computer systems do not conveniently allow for the use of the mouse.

Since the stylus typically has only a single event capability when it makes contact with the screen, the stylus is dedicated to performing key actions such as selection of a hyperlink, execution of a control, etc. When the stylus comes into contact with the touch screen, the contact is interpreted as a left button down at the corresponding touch screen coordinates. Lifting the stylus generates a left button up event. Thus, as defined above, the combination of stylus down followed by stylus up is interpreted as a left click.

In many instances, however, the stylus is used to interface with applications originally designed for use with a mouse. As such, using a stylus that only signals left click events limits functionalities of these applications. In this sense, the mouse offers advantages over the stylus. For example, the mouse cursor can be moved without committing to an action and still is able to provide the user information through the hover capability.

The ability for a stylus to achieve more of the functions of a mouse (e.g., both left and right button up and down events, etc.) has been a subject of many research efforts. There are sophisticated and significantly expensive touch screen systems available on the market today using styluses that include electronics or styluses that generate electrical signals. Such systems are often expensive to implement.

### BRIEF DESCRIPTION OF THE DRAWINGS

The following drawings disclose various embodiments of the present invention for purposes of illustration only and are not intended to limit the scope of the invention.

FIG. 1A is a diagram illustrating an example of a ballpoint stylus having a tip attached to an internal shaft, according to one embodiment.

FIG. 1B is a diagram illustrating a close up view of a tip of a ballpoint stylus, according to one embodiment.

FIG. 2A is a diagram illustrating an example of a ballpoint stylus tip and its different configurations, according to one embodiment.

FIG. 2B is a diagram illustrating an example of a ballpoint stylus that does not use a tip and how it may be used to initiate different mouse actions according to one embodiment.

FIG. 3A is an example of a one-tip ballpoint stylus according to one embodiment.

FIG. 3B is an example of a dual-tip ballpoint stylus according to one embodiment.

FIG. 3C is a table example illustrating different scenarios using a single stylus tip ballpoint stylus, according to one embodiment.

FIG. 3D is a table example illustrating different scenarios using a dual stylus tips ballpoint stylus, according to one embodiment.

FIG. 4 is a flow diagram illustrating an example of a process used to identify different mouse actions when using a ballpoint stylus according to one embodiment.

FIG. 5 is a block diagram illustrating an example of a computer system that may be used according to one embodiment.

### DETAILED DESCRIPTION

For one embodiment, a method for initiating different mouse actions using a stylus is disclosed. The stylus may be a ballpoint stylus having a tip and a moveable ball. A mouse action is initiated when the ball is in contact with a touch-sensitive surface.

In the following description, for purposes of explanation, numerous specific details are set forth in order to provide a thorough understanding of the present invention. It will be evident, however, to one skilled in the art that the present invention may be practiced without these specific details. In other instances, well-known structures, processes and devices are shown in block diagram form or are referred to in a summary manner in order to provide an explanation without undue detail.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur.

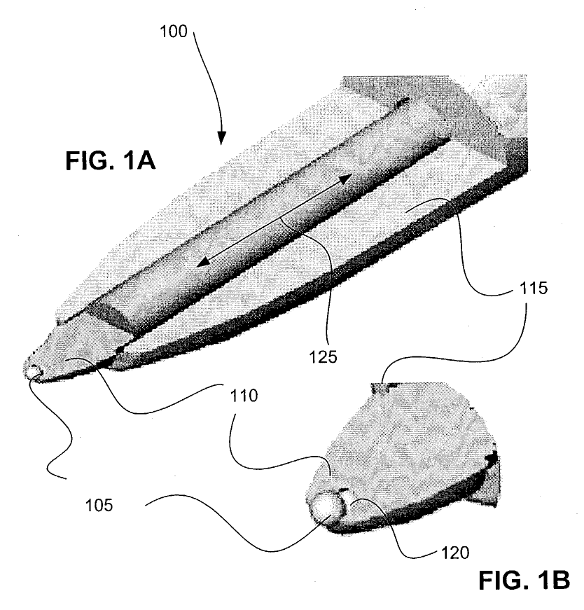

FIG. 1A is a diagram illustrating an example of a ballpoint stylus having a tip attached to an internal shaft, according to one embodiment. The stylus 100 includes a housing 115, and a tip 110. For one embodiment, the tip 110 is attached to a shaft 125. The tip 110 includes a ball 105. The tip 110 may move within the housing 115. For example, when there is sufficient pressure applied to the tip 110, the tip 110 (and the shaft 125) may move deeper along the longitudinal direction of the housing 115. Different mechanisms may be used to assist with the movement of the tip 110 (and the shaft 125) within the housing 115. For example, the tip 110 may be coupled to an elastic mechanism (not shown) to assist with its movement.

FIG. 1B is a diagram illustrating a close up view of a tip of a ballpoint stylus, according to one embodiment. For one embodiment, the tip 110 includes an open cavity 120. The ball 105 is coupled to the tip 110 at the open cavity 120. For one embodiment, the ball 105 may be partially protruding from the open cavity 120. This may be a default position of the ball 105. The ball 105 may remain generally in the same protruding position when light pressure is applied to the ball 105. For another embodiment, when increasing pressure is applied to the ball 105, the ball 105 may move inward into the open cavity 120. This may occur when the tip 110 remains generally in the same position relative to the housing 115.

For another embodiment, when the increasing pressure applied to the ball 105 exceeds a certain pressure threshold, the tip 110 may move inward into the housing 115. Pressure may be applied to the ball 105 by pressing the tip 110 and the ball 105 against a touch-sensitive surface. For example, the touch-sensitive surface may be a touch screen used with a tablet computer. For one embodiment, the stylus 100 may be a mechanical stylus. For example, the stylus 100 may not include any electronics or any components capable of causing the stylus 100 to generate electrical signals necessary for recognizing the different mouse actions.

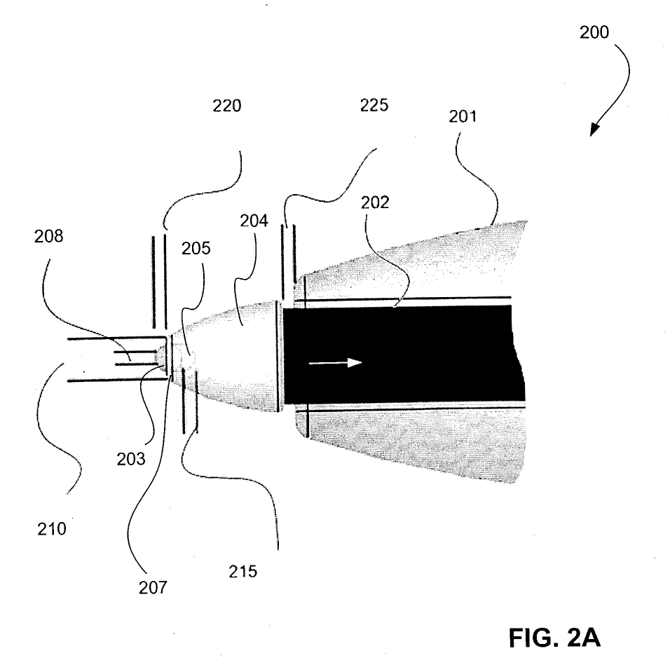

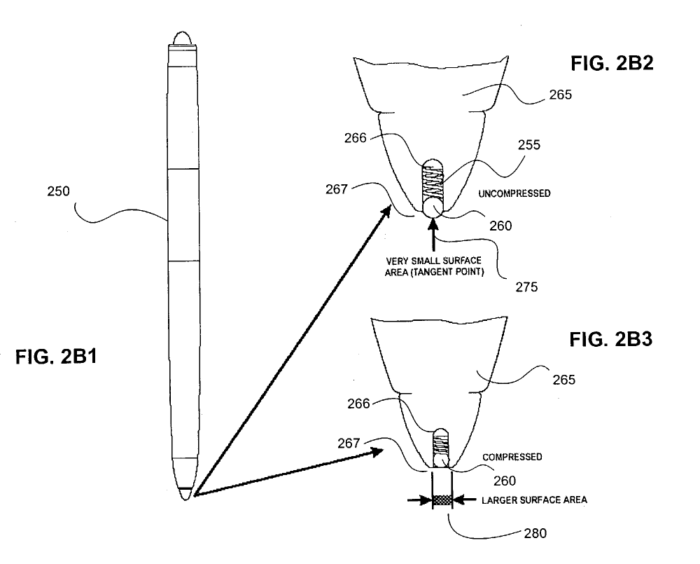

FIG. 2A is a diagram illustrating an example of a tip of a stylus and its different configurations, according to one embodiment. The stylus 200 includes a housing 201, and a tip 204. The tip 204 includes a ball 203 and may be attached to a shaft 202. The tip 204 also includes a collar 207, and an open cavity 205 formed near the collar 207. The ball 203 may protrude partially outside of the cavity 205 at the collar 207. For example, the portion of the ball 203 that protrudes outside of the cavity 205 may be indicated as space 220 between the collar 207 and the protruding end of the ball 203. It may be noted that the ball 203 may be protruding from the cavity 205 without being completely separated from the cavity 205.

For one embodiment, the cavity 205 may include properties to allow it to accept the ball 203 when pressure is applied to the ball 203. The cavity 205 may also include properties to allow it to return the ball 203 to its default position when little or no pressure is applied to the ball 203. When the ball 203 is in its protruding position, the surface contact area between the tip 204 and the touch-sensitive surface may be circular having a diameter 208.

When the stylus 200 is used as an input device by pressing the tip 204 and the ball 203 against a touch-sensitive surface (not shown), different mouse actions may be initiated depending on the pressing pressure exerted on the stylus 200. For one embodiment, when the pressure is in a first range, the ball 203 may remain generally in its protruding position, and a first mouse action may be recognized by logic associated with the touch-sensitive surface. The first mouse action may be, for example, a left button single click.

For one embodiment, when the pressure is in a second range, the ball 203 may be pushed inward into the cavity 205 (at an additional depth of 215). This may cause the collar 207 to be in contact with the touch-sensitive surface. In this situation, a second mouse action may be recognized by the logic associated with the touch-sensitive surface. It may be noted that when the collar 207 is in contact with the touch-sensitive surface, the surface contact area between the tip 204 and the touch-sensitive surface is larger than the surface contact area created when the ball 203 is in its protruding position, as described above. For example, the surface contact area created when the collar 207 is in contact with the touch-sensitive surface may be circular having a diameter 210. It may be noted that when the collar 207 is in contact with the touch-sensitive surface, the ball 203 may also be in contact with the touch-sensitive surface. The second mouse action may be, for example, a left button double click.

For one embodiment, when the pressure is in a third range, in addition to the ball 203 being pushed inward into the cavity 205 and the collar 207 making contact with the touch-sensitive screen, the shaft 202 may be pushed inward into the housing 201 (indicated by the directional arrow along the shaft 202). For example, the shaft 202 may be pushed inward into the housing 201 for a distance represented as 225. In this situation, a third mouse action may be recognized by the logic associated with the touch sensitive surface. The third mouse action may be, for example, a right button single click. It may be noted that when no pressure is applied to the ball 203 or when the stylus 200 is not in contact with the touch-sensitive surface, the ball 203 returns to its default position (e.g., partially protruding from the cavity 205). It may also be noted that there may be a slight movement of the shaft 202 when the first mouse action or the second mouse action is recognized. However, the pressure that causes this slight movement may not be sufficient enough to be in the third range to cause a third mouse action to be recognized. One may combine the first pressure range and the second pressure range into one large pressure range to distinguish a range that does not cause the shaft 202 to move and a range that causes the shaft 202 to move.

FIGS. 2B1-2B3 are diagrams illustrating another example of a stylus tip, according to one embodiment. The stylus 250 includes a tip 265. The tip 265 includes a ball 260. For one embodiment, the tip 265 may not be moveable and may not be attached to a shaft. This is different from the stylus illustrated in FIG. 2A. The tip 265 includes a collar 267, and an open cavity 266, as illustrated in FIGS. 2B2 and 2B3. The ball 260 may protrude partially outside of the open cavity 266 at the collar 267. It may be noted that when the stylus 250 is in contact with a touch-sensitive surface, and the ball 260 is protruding from the open cavity 266, as illustrated in FIG. 2B2, the surface contact area 275 between the stylus 250 and the touch-sensitive surface may be small. However, when the ball 260 is retracted further into the open cavity 266, as illustrated in FIG. 2B3, the surface contact area 280 between the stylus 250 and the touch-sensitive surface may be larger. In this example, the surface area 280 may include contact made by the collar 267 and the touch-sensitive screen. The surface area 280 may also include contact made by the ball 260 and the touch-sensitive screen. The surface area 275 and the surface area 280 in this example may be used to identify a first mouse action and a second mouse action, respectively.

For one embodiment, the open cavity 266 may include an elastic mechanism 255. The elastic mechanism 255 may be a spring. The elastic mechanism 255 may be coupled to the ball 260 to help with the movement of the ball 260. For example, when the tip 265 of the stylus 250 is pressed against a surface, the elastic mechanism 255 may be in its compressed form. When the tip 265 of the stylus 250 is not pressed against the surface, the elastic mechanism 255 may be in its uncompressed form and the ball 260 is restored to its default partially protruding position.

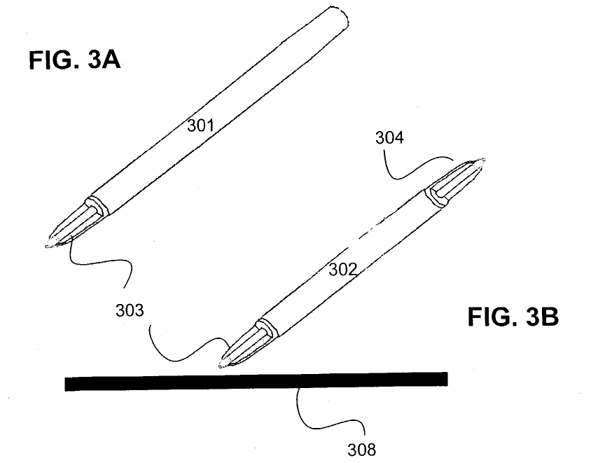

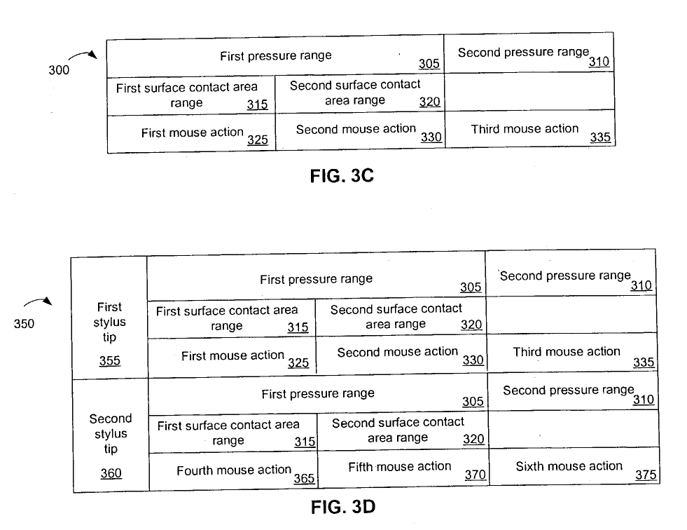

A ballpoint stylus may have one tip 303 as illustrated by the stylus 301 in FIG. 3A. For one embodiment, a ballpoint stylus may have two tips 303 and 304 as illustrated by the stylus 302 in FIG. 3B. The tip 303 and the tip 304 may include features to enable the touch-sensitive surface 308 to distinguish one from the other. For example, the size of the ball and the collar associated with the tip 303 may be different from the size of the ball and the collar associated with the tip 304. As another example, the ball associated with the tip 303 may be made of a material different from the material used for the ball associated with the tip 304. Other techniques may also be used to differentiate the two tips 303 and 304. This may allow each of the tips 303 and 304 to be recognized as a different signature by the computer system associated with the touch-sensitive surface 308. Each of the tips 303 and 304 may have the same properties (e.g., a cavity, a ball, etc.) as described in FIG. 2A. This may allow the stylus 302 to be used to initiate up to six different mouse actions. A common shaft may be used in the stylus 302, or two separate shafts may be used, one at each end of the stylus 302. Alternatively, there may not be any shaft and the tips 303 and 304 may be non-moveable, as described in FIGS. 2B1-2B3. In this case, the stylus 302 may be used to initiate up to four different mouse actions.

FIG. 3C is a table example illustrating different scenarios using a stylus having a single tip, according to one embodiment. The table may be used by a computer system to recognize different mouse actions when the stylus is in contact with a touch-sensitive screen 308 associated with the computer system. Table 300 lists a first pressure range 305 and a second pressure range 310. The first pressure range may include a pressure level applied against the touch-sensitive surface 308 when the only the ball is in contact with the touch-sensitive surface 308 and a pressure level applied when the collar is in contact with the touch-sensitive surface 308. When only the ball is in contact with the touch-sensitive surface 308, the surface contact area may be in the first surface contact area range 315. This may be recognized by the computer system as a first mouse action 325. When the collar is in contact with the touch-sensitive surface 308, the surface contact area may be in the second surface contact area range 320. This may be recognized by the computer system as a second mouse action 330. The first mouse action 325 and the second mouse action 330 may be generated using the stylus 200 described in FIG. 2A having a moveable tip and the stylus 250 described in FIG. 2B1 having a non-moveable tip.

The second pressure range may include a pressure level applied against the touch-sensitive surface 308 such that a moveable tip moves inward into the housing of the stylus. This may be recognized by the computer system as a third mouse action 335. The third mouse action 335 may be generated using the stylus 200 described in FIG. 2A.

FIG. 3D is a table example illustrating different scenarios using a dual tips stylus, according to one embodiment. In this example, the stylus has a moveable tip as described in FIG. 2A. When the first tip 355 is used, the computer system may recognize the first three mouse actions as described in FIG. 3C. For one embodiment, when the computer system recognized that the second tip 360 is used to input, it may be able to recognize the fourth mouse action 365, the fifth mouse action 370, and the sixth mouse action 375 using the same surface contact area ranges 315 and 320 and the pressure ranges 305 and 310 as described in FIG. 3C. Other criteria may also be used to recognize the fourth, fifth, and sixth mouse actions 365, 370 and 375. For example, a different surface contact area range may be used.

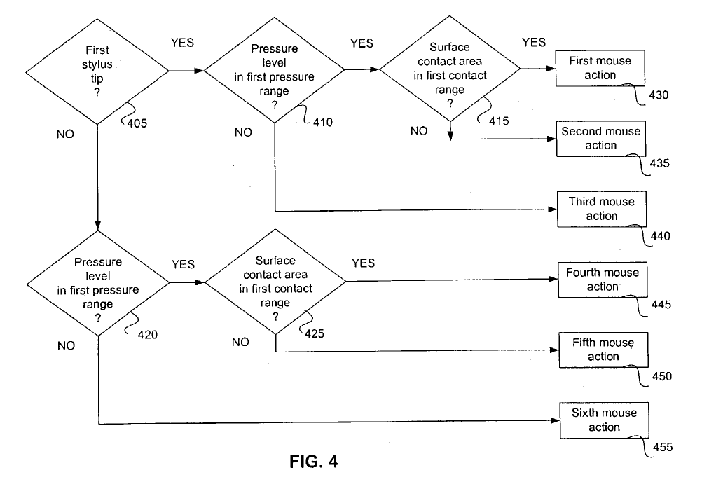

FIG. 4 is a flow diagram illustrating an example of a process used to identify different mouse actions when using a stylus according to one embodiment. The stylus in this example may include two tips referred to as a first tip and a second tip. The process may be performed by a computer system coupled to a touch-sensitive surface. The process may be used to recognize a mouse action when using the stylus as an input device. At block 405, a test is made to determine whether the tip in contact with the touch-sensitive surface is the first tip or the second tip. When it is the first tip, the process flows from block 405 to block 410. At block 410, a test is made to determine if the pressure level is in a first pressure range. If it is, the process flows from block 410 to block 415 where a third test is made to determine a surface contact area. If the surface contact area is in a first range, then the first mouse action is recognized, as shown in block 430. If the surface contact area is not in the first range (i.e., it is in the second surface contact area range), then the second mouse action is recognized, as shown in block 435.

From block 410, if the pressure level is not in the first range (i.e., it is in the second pressure range), then the third mouse action is recognized, as shown in block 440. It may be noted that the process up to this point may apply to both a single tip stylus and a dual tips stylus to recognize the first three mouse actions.

From block 405, if it is not the first tip (i.e., it is the second tip), then the process flows to block 420 where a test is made to determine if the pressure level is in the first pressure range. Note that in this example, the same pressure range is being used for the first pressure range and the second pressure range. Similarly, the same surface contact area range is being used for the first surface contact area and the second surface contact area. As noted above, different pressure range and surface contact area may also be used. From block 420, if the pressure level is in the first pressure range, the process flows to block 425 where a test is made to determine if the surface contact area is in the first contact area range. If it is, the fourth mouse action is recognized, as shown in block 445. From block 425, if the surface contact area is not in the first contact area range, then the fifth mouse action is recognized, as shown in block 450. From block 420, if the pressure level is not in the first range, then the sixth mouse action is recognized, as shown in block 455.

The touch-sensitive surface 308 illustrated in FIG. 3B may be capable of sensing and ignoring a pressure that is less than a predetermined threshold pressure as a non-event. Similarly, the touch sensitive surface 308 may be capable of sensing a pressure that is higher than the predetermined threshold pressure as a real event that needs to be processed accordingly. Touch screen logic (e.g., software drivers) may be used to sense the different pressures and different surface contact areas at the contact point.

For one embodiment, when the touch screen logic (e.g., touch screen software driver) identifies an event as a real event, the touch screen logic may further distinguish the real event as one of different associated mouse actions. For example, the touch screen logic may use a comparator to compare the identified surface contact area with predetermined ranges of surface contact areas to identify the appropriate mouse actions.

For one embodiment, the touch-sensitive surface 308 may include a transducer (not shown) to sense or be able to respond to different characteristics of the tip of the stylus. These characteristics may include, for example, geometry, mechanical, etc. The transducer may be part of the touch-sensitive surface 308. The transducer may perform the sensing logic function to, for example, convert the recognized pressure level exerted by the tip to associated electrical signals associated with the mouse actions. The transducer may also perform the sensing logic function to, for example, translate the surface contact area to associated electrical signals associated with the mouse actions. For one embodiment, the touch-sensitive surface 308 may include logic (e.g., software, hardware, or both) that enables the touch-sensitive surface 308 to have the same level of sensitivity at different surface locations, thus overcoming the spatial variance in touch sensitivity that typically exists for these types of devices. This may allow the same contact with the tip to be identified as the same mouse action regardless of the surface locations.

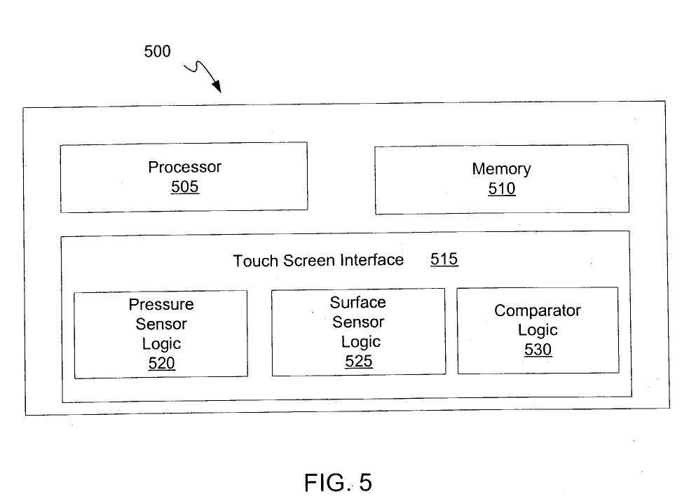

FIG. 5 is a block diagram illustrating an example of a computer system that may be used according to one embodiment. The stylus described in FIGS. 2A and 2B1 may be used to interact with a computer system 500 having the touch-sensitive surface that is capable of recognizing different mouse actions depending on the type of contact caused by the stylus. The type of contact by the stylus may include, for example, surface contact area formed between the stylus and the touch-sensitive surface, pressure exerted by the stylus against the touch-sensitive surface, etc. The computer system 500 may include logic to perform various operations, including logic to identify different surface contact areas and logic to identify different pressure ranges. The computer system 500 may also include logic to perform comparison to recognize different mouse actions based on the identified surface contact area and identified pressure ranges.

The computer system 500 may include a processor 505 and a memory 510. The memory 510 may be random access memory (RAM), read only memory (ROM), a persistent storage memory, such as mass storage device or any combination of these devices. The computer system 500 also includes a touch screen interface 515. The touch screen interface 515 may include pressure sensor logic 520 to determine different pressure levels exerted by the tip against the touch-sensitive surface. The touch screen interface 515 may also include surface sensor logic 525 to determine surface contact area at the contact points. Further more, the touch screen interface 515 may also include comparator logic 530 to compare the surface contact area and the pressure level with predetermined ranges of pressure levels and surface contact areas.

The processor 505 may execute sequences of computer program instructions that may be stored in the memory 510 which may be considered to be a machine-readable storage media. Execution of the sequences of instructions may cause the processor 505 to perform operations according to the processes described above, for example. The instructions may be loaded into the memory 510 from a storage device or from one or more other computer systems (e.g., a server computer system) over a network connection.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A stylus for generating mouse actions, comprising:
a tip, the tip including an open cavity;
a ball coupled to the tip at the open cavity and partially protruding from the open cavity in its default position, wherein when the ball is in contact with a surface at its default position, a first mouse action is recognized.

2. The stylus of claim 1, wherein the ball is capable of being protracted into the open cavity when the ball is pressed against the surface with pressure in a first range.

3. The stylus of claim 2, wherein the tip further includes a collar around an open end of the open cavity, and wherein in its default position the ball is partially protruding from the open cavity surrounded by the collar.

4. The stylus of 3, wherein when the ball is protracted into the open cavity such that the collar is in contact with the surface, a second mouse action is recognized.

5. The stylus of claim 4, wherein the tip further includes an elastic mechanism in the open cavity, wherein the elastic mechanism is coupled to the ball and assist in restoring the ball from a protracted position to the default position.

6. The stylus of claim 1, wherein the tip is non-moveable.

7. The stylus of claim 1, wherein the tip is moveable.

8. The stylus of claim 7, wherein the tip is moveable when the ball is pressed against the surface with pressure in a second range.

9. The stylus of claim 8, wherein when the ball is pressed against the surface with pressure in the second range, a third mouse action is recognized.

10. The stylus of claim 1, wherein the surface is a touch-sensitive surface.

11. A method, comprising:
recognizing a first mouse action when a stylus is placed in contact with a touch-sensitive surface such that a ball coupled to a tip of the stylus is in contact with the touch-sensitive surface, wherein the ball is coupled to the tip at an open cavity of the tip and partially protruding from the open cavity.

12. The method of claim 11, wherein a first surface contact area is formed between the ball and the touch-sensitive area when the first mouse action is recognized.

13. The method of claim 11, wherein the ball is partially inside the open cavity when the first mouse action is recognized.

14. The method of claim 13, wherein the open cavity includes a collar where the ball is partially protruding from the open cavity.

15. The method of claim 14, further comprising:
recognizing a second mouse action by pressing the ball against the touch-sensitive surface such that the ball is retracted into the open cavity allowing the collar to be in contact with the touch-sensitive surface.

16. The method of claim 15, wherein a second surface contact area is formed between the ball and the touch-sensitive area when the second mouse action is recognized.

17. The method of claim 16, wherein the second surface contact area is larger than the first contact area.

18. A stylus, comprising:
a first tip; and
a first ball coupled to the first tip at an open cavity of the first tip, wherein a first mouse action is associated with the first ball being partially protruding from the open cavity and a second mouse action being associated with the first ball not being partially protruding from the open cavity.

19. The stylus of claim 18, wherein the first mouse action is recognized when the first ball is in contact with a touch-sensitive surface.

20. The stylus of claim 19, wherein the open cavity of the first tip includes a collar at an opening of the open cavity of the first tip, and wherein the first ball is partially protruding from the open cavity of the first tip at the collar when the first mouse action is recognized.

21. The stylus of claim 20, wherein the second mouse action is recognized when the collar is in contact with the touch-sensitive surface.

22. The stylus of claim 18, further comprising:
a second tip coupled to a second ball, the second tip used to enable a third mouse action and a fourth mouse action to be recognized when placed in contact with the touch-sensitive surface.

23. The stylus of claim 22, wherein the third mouse action is recognized when the second ball of the second tip is in contact with the touch-sensitive surface.

24. The stylus of claim 22, wherein the second tip includes a second open cavity, and wherein the third mouse action is recognized when the second ball is protruding partially outside of the second open cavity.

25. The stylus of claim 24, wherein the fourth mouse action is recognized when the second tip is in contact with the touch-sensitive surface while the second ball is retracted inside the second open cavity.

26. The stylus of claim 24, wherein the fourth mouse action is recognized when the second ball is not protruding from the second open cavity.

27. The stylus of claim 22, wherein the first ball and the second ball have different properties.

28. The stylus of claim 27, wherein the first ball and the second ball have different physical properties.

29. The stylus of claim 22, wherein the first tip and the second tip are positioned at opposite ends.
